(19) United States
(12) Patent Application Publication
(10) Pub. No.: US 2024/0119234 A1
(43) Pub. Date: Apr. 11, 2024

(54) SYSTEMS AND METHODS FOR SENTIMENT EXTRACTION IN NATURAL LAGUAGE PROCESSING BASED ON GRAPH-BASED MODELS, AND INDICATORS FOR TRADING PLATFORMS

(71) Applicant: Kovach Technologies Inc, Tampa, FL (US)

(72) Inventor: Daniel Kovach, Tampa, FL (US)

(73) Assignee: Kovach Technologies Inc, Tampa, FL (US)

(21) Appl. No.: 18/475,159

(22) Filed: Sep. 26, 2023

Related U.S. Application Data
(60) Provisional application No. 63/377,295, filed on Sep. 27, 2022.

(51) Int. Cl. G06F 40/30; G06F 40/247; G06N 3/08

(52) U.S. Cl. CPC G06F 40/30; G06F 40/247; G06N 3/08

(57) ABSTRACT

System and methods for extracting sentiment from statements using graph-based classification models. In embodiments, an input statement is divided into a set of bigrams, each bigram composed of a respective pair of neighboring words in the input statement. A relationship between the neighboring words is identified for each bigram of the set of bigrams using a graph-based NLP classification model having a plurality of nodes, each node associated with a node of the graph-based NLP classification model. The relationship between two nodes includes information for determining a sentiment classification associated with the relationship between the two nodes. A sentiment classification for each bigram of the set of bigrams is determined based on the relationship between the respective neighboring words of each bigram, and an overall sentiment classification for the input statement is determined based on a summation of the sentiment classification for each bigram of the set of bigrams.

### CROSS-REFERENCE TO RELATED APPLICATIONS

The present application claims priority to U.S. Prov. App. Ser. No. 63/377,295 filed on Sep. 27, 2022, titled “SYSTEMS AND METHODS FOR SENTIMENT EXTRACTION IN NATURAL LANGUAGE PROCESSING BASED ON GRAPH-BASED MODELS, AND INDICATORS FOR TRADING PLATFORMS,” the entirety of which is incorporated herein by reference for all purposes.

### TECHNICAL FIELD

The present disclosure relates generally to natural language processing (NLP) classification systems, and more particularly to a system for extracting sentiment based on graph-based classification models.

### BACKGROUND

It is not a stretch to say that data analysis is the bloodline of most current technologies. The vast majority of our knowledge is gained by the analysis of collected data. In light of this fact, data analysis techniques have been developed and improved over the years in order to handle the ever-growing amounts of data that we have gathered and/or accumulated. However, current data analysis techniques rely on substantial and advanced computational and processing resources to be able to handle the analysis. This not only stops entities with limited resources from being able to perform meaningful data analysis, but even those entities with sufficient resources must allocate large amounts of resources to data analytics, which locks out those resources from being used or leveraged for other operations.

One particular application of data analysis is natural language processing (NLP), which relies heavily in artificial intelligence (AI), including machine learning (ML) techniques. NLP has evolved greatly in the last several decades, thanks in part to the exponential growth of computational resources, which has made practical implementation of advanced models more accessible. Applications of NLP may include sentiment analysis in which NLP models may be used to determine qualitative states of subjective text information (e.g., positivity or negativity of a particular statement), chat bots in which human interaction pipelines (e.g., customer and technical support) may be automated, text classification in which text may be classified into categories (e.g., classifying an email or text as spam, etc.), search results in which NLP models are used by search engines to better match search results with respect to users' queries, language translation in which NLP models are used to identify similarities between languages and to optimize translation (e.g., NLP models have been used to decipher dead language never before translated by humans), etc.

However, current NLP approaches rely on techniques that require large amounts of data to train the NLP models and/or require complex operations (e.g., matrix-based operations) on substantially large amounts of data to process language statements to extract meaningful features within acceptable accuracies. This, as noted above, requires substantial amounts of computational power and data, which may be a very expensive proposition.

For example, in some cases, NLP data may be presented as sparse data, in which a high percentage of the data structures, or a high portions of each data structures, do not contain actual data. This is because, for example, most language statements include a relatively few words when compared to the corpus making up the language of the statement. As such, processing the sparse data uses large data structures even though a high percentage or portions of the data structures are actually empty.

In addition, current NLP models have difficulty processing statements that include words not previously seen by the NLP model (e.g., words that were not explicitly used in the training of the NLP models). In this manner, current NLP models may not be able to leverage their functionality when encountering data not previously seen by the NLP model thereby limiting their flexibility and adaptability.

### SUMMARY

The present disclosure achieves technical advantages as a system and method for extracting sentiment from statements using graph-based classification models that can address the deficiencies of current systems. In aspects, the present disclosure provides for a system with enhanced preprocessing that enables a classification system to better understand common terms, such as word-pairs (e.g., terms expressed as colocations) or common tags or names. In aspects, a system may implement an enhanced graph-based natural language processing (NLP) classification model that provides graph-based NLP classification. In particular, the graph-based NLP classification model of aspects may implement a graph-based approach to NLP classification. For example, in aspects, an input statement may be divided into a set of bigrams, where each bigram may be composed of a respective pair of neighboring words in the input statement. A relationship between the neighboring words may then be identified for each bigram of the set of bigrams. In aspects, the relationship between the neighboring words may be identified using a graph-based NLP classification model having a plurality of nodes, each node associated with a node of the graph-based NLP classification model. In aspects, the relationship between two nodes of the graph-based NLP classification model may include information for determining a sentiment classification associated with the relationship between the two nodes. In aspects, a sentiment classification for each bigram of the set of bigrams may be determined based on the relationship between the respective neighboring words of each bigram, and then an overall sentiment classification for the input statement may be determined based on a summation of the sentiment classification for each bigram of the set of bigrams.

In this manner, the present disclosure provides as technological solution that solves the technological problem associated with typical NLP classification approaches for extracting sentiment, such as requiring large amounts of data to train a classification model and/or complex matrix-based operations to extract sentiment, which increases the cost and complexity of NLP operations in conventional systems. The present disclosure provides a technological solution missing from conventional systems by providing graph-based NLP classification techniques that allow for sentiment extraction with relatively smaller amounts of data and with less complex operations. Accordingly, the present disclosure discloses concepts inextricably tied to computer technology such that the present disclosure provides the technological benefit of performing NLP classification with less required data (e.g., for training), which enables more economical operations, both in terms of finances and data storage requirements, as well as with less complex operations, such as using graph-based operations rather than matrix-based operations on the sparse data, which results in a substantial savings of processing power. Indeed, in some embodiments, using the techniques disclosed herein, NLP classification operations may be performed using graph-based NLP classification models of embodiments in a Raspberry Pi setup, where the same NLP classification operations implemented using typical NLP approaches may require substantially more computing resources, such as a system with much higher processing power than the Raspberry Pi setup, and may not be able to be implemented using the Raspberry Pi setup. Thus, the present disclosure provides a computing resource savings that represents a substantial improvement in the efficiency of a system configured to perform NLP classification.

It is an object of the disclosure to provide a method of identifying sentiment of a statement using graph-based NLP classification models. It is a further object of the disclosure to provide a system for identifying sentiment of a statement using graph-based NLP classification models, and a computer-based tool for identifying sentiment of a statement using graph-based NLP classification models. It is a further object of the disclosure to provide a method of training a graph-based NLP classification model. These and other objects are provided by the present disclosure.

In one particular embodiment, a method of identifying sentiment of a statement using graph-based NLP classification models is provided. The method includes dividing an input statement into a set of bigrams. In embodiment, each bigram of the set of bigrams is composed of a respective pair of neighboring words in the input statement. The method also includes identifying, for each bigram of the set of bigrams, a relationship between the respective neighboring words using a graph-based NLP classification model. In embodiment, a relationship between two nodes of the graph-based NLP classification model includes information for determining a sentiment classification associated with the relationship between the two nodes. The method further includes determining a sentiment classification for each bigram of the set of bigrams based on the relationship between the respective neighboring words of each bigram, and determining an overall sentiment classification for the input statement based on a summation of the sentiment classification for each bigram of the set of bigrams.

In another embodiment, a system for identifying sentiment of a statement using graph-based NLP classification models is provided. The system comprises at least one processor and a memory operably coupled to the at least one processor and storing processor-readable code that, when executed by the at least one processor, is configured to perform operations. The operations include dividing an input statement into a set of bigrams. In embodiment, each bigram of the set of bigrams is composed of a respective pair of neighboring words in the input statement. The operations also include identifying, for each bigram of the set of bigrams, a relationship between the respective neighboring words using a graph-based NLP classification model. In embodiment, a relationship between two nodes of the graph-based NLP classification model includes information for determining a sentiment classification associated with the relationship between the two nodes. The operations further include determining a sentiment classification for each bigram of the set of bigrams based on the relationship between the respective neighboring words of each bigram, and determining an overall sentiment classification for the input statement based on a summation of the sentiment classification for each bigram of the set of bigrams.

In still another embodiment, a computer-based tool for identifying sentiment of a statement using graph-based NLP classification models is provided. The computer-based tool including non-transitory computer readable media having stored thereon computer code which, when executed by a processor, causes a computing device to perform operations. The operations include dividing an input statement into a set of bigrams. In embodiment, each bigram of the set of bigrams is composed of a respective pair of neighboring words in the input statement. The operations also include identifying, for each bigram of the set of bigrams, a relationship between the respective neighboring words using a graph-based NLP classification model. In embodiment, a relationship between two nodes of the graph-based NLP classification model includes information for determining a sentiment classification associated with the relationship between the two nodes. The operations further include determining a sentiment classification for each bigram of the set of bigrams based on the relationship between the respective neighboring words of each bigram, and determining an overall sentiment classification for the input statement based on a summation of the sentiment classification for each bigram of the set of bigrams.

In yet another embodiment, a method of training a graph-based NLP classification model is provided. The method includes generating, before the NLP classification model is trained, a knowledge corpus of a language to be used by the NLP classification model. In embodiments, the knowledge corpus specifies a relationship between words. The method also includes generating, based on the knowledge corpus, a set of abstract nodes corresponding to equivalence classes of words in the knowledge corpus. In embodiments, each node of the set of abstract nodes represents an equivalence class of the equivalence classes. The method also includes generating, based on a training set of input statements including labeled data, relationships between abstract nodes of the set of abstract nodes. In embodiments, each input statement is associated with one of a set of sentiments, the labeled data includes numeric data relating to the sentiment of the set of possible sentiments for corresponding input statements, and a relationship between a first node and a second node of the set of abstract nodes is based on an order of the first node and the second node within the sentence. In embodiments, generating a relationship between the first node and the second node includes identifying, for a first input statement of the training set of input statements, a sentiment associated with the first input statement, and incrementing a component of a vector associated with the sentiment associated with the first input statement. In embodiments, the vector is associated with the relationship between the first node and the second node, and training includes incrementing pairwise across each input statement, updating the respective relationships between nodes, then moving on to the next vector.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 a block diagram of a system providing functionality for extracting sentiment from statements using graph-based classification models in accordance with aspects of the present disclosure;

FIG. 2 is a diagram illustrating an example of a graph generation using a graph-based classification model in accordance with aspects of the present disclosure;

FIG. 3 shows a high-level flow diagram of operations of a system for providing functionality for identifying sentiment of a statement using graph-based NLP classification models in accordance with embodiments of the present disclosure.

FIG. 4 shows a high-level flow diagram of operations of a system for providing functionality for training a graph-based NLP classification model in accordance with embodiments of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Various embodiments of the present disclosure are directed to systems and techniques that provide functionality for extracting sentiment from statements using graph-based natural language processing (NLP) classification models. In particular embodiments, a system with enhanced preprocessing may enable a classification system to better understand common terms, such as word-pairs (e.g., terms expressed as colocations) or common tags or names. In embodiments, a system may implement an enhanced graph-based NLP classification model that provides graph-based NLP classification. In particular, the graph-based NLP classification model of embodiments may implement a graph-based approach to NLP classification. For example, an input statement may be divided into a set of bigrams, where each bigram may be composed of a respective pair of neighboring words in the input statement. A relationship between the neighboring words may then be identified for each bigram of the set of bigrams. In embodiments, the relationship between the neighboring words may be identified using a graph-based NLP classification model having a plurality of nodes, each node associated with a node of the graph-based NLP classification model. In embodiments, the relationship between two nodes of the graph-based NLP classification model may include information for determining a sentiment classification associated with the relationship between the two nodes. In embodiments, a sentiment classification for each bigram of the set of bigrams may be determined based on the relationship between the respective neighboring words of each bigram, and then an overall sentiment classification for the input statement may be determined based on a summation of the sentiment classification for each bigram of the set of bigrams.

It will be appreciated that the benefits that the techniques of the present disclosure provide include an ability to tackle NLP classification problems using “less data” and less complex operations than conventional systems. For example, in conventional data analytics, NLP classification problems are handled with matrix operations-based solutions. Matrix operations-based solutions may include approaches in which data is represented as vectors or matrices and matrix operations are applied to the data in order to obtain results. In an example of NLP, statements are analyzed by running statements through NLP models against a bag of words and generating vectors representing the words in the statements. For example, each word in the bag of words may have an index in the vector and, if a word in a statement is present in the bag of words, the index in the vector corresponding to the word is tagged (e.g., with a 1 or another indication). Thus, for a statement, a vector may be generated having a dimensionality equal to the number of words in the bag of words, but with only a very small number of indices tagged. This is because most statements include only a relatively small number of words, but a bag of words in NLP may include thousands of data points. In this case, NLP may include applying matrix operations to the statement vectors. However, as the statement vectors have large dimensionalities, the matrix operations require substantially large amounts of computations and processing power. Embodiments, of the present disclosure allow for NLP classification to be performed using a graph-based approach, which allows for NLP classification using significantly less data than required by matrix-based approaches.

In addition, the techniques disclosed herein may also allow for an improved accuracy of NLP classification by categorizing tokens, rather than the traditional NLP approach in which each token is vectorized. In this manner, even if a token (e.g., a word) has not been encountered by the graph-based NLP classification model of embodiments, the token may be classified, which may not be possible with traditional NLP approaches which rely on training the NLP model with known tokens.

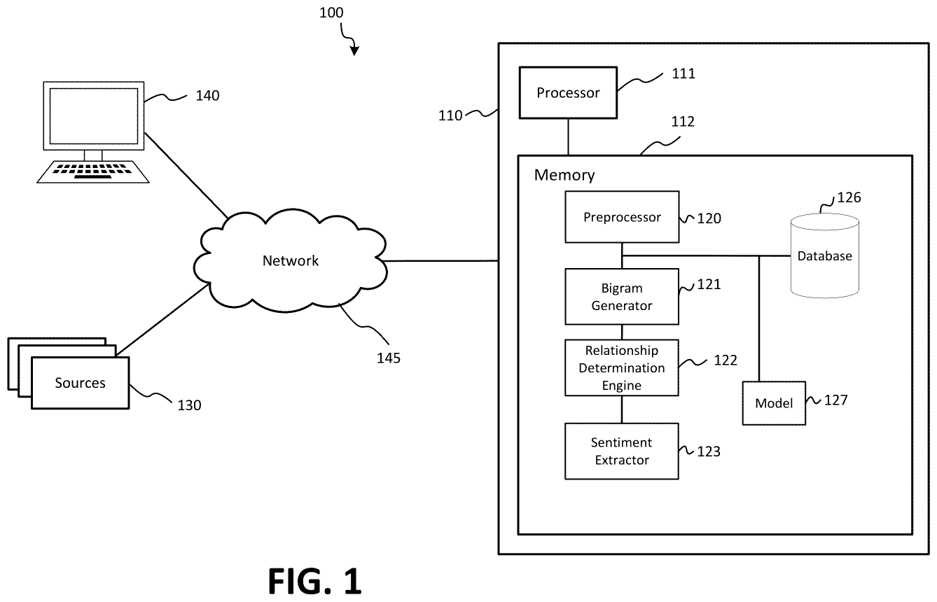

FIG. 1 is a block diagram of an exemplary system 100 configured with capabilities and functionality for extracting sentiment from statements using graph-based NLP classification models in accordance with embodiments of the present disclosure. As shown in FIG. 1, system 100 may include server 110, sources 130, user interface 140, and network 145. These components, and their individual components, may cooperatively operate to provide functionality in accordance with the discussion herein. For example, in operation according to embodiments, at least one statement (e.g., in one or more documents from sources 130) may be received (e.g., extracted, transmitted, etc.) from sources 130. In embodiments, the at least one statement may be transmitted, e.g., via network 145, to server 110. In some embodiments, a user may request analysis (e.g., sentiment extraction processing) using user terminal 140. In embodiments, functionality of server 110 may operate to extract sentiment from the at least one statement using a graph-based NLP classification model. In some embodiments, results of the sentiment extraction in accordance with embodiments of the present disclosure may be used by an external system (e.g., a trading system to drive transactions, a trading indicator system to generate indicators, etc.), or may be provided to the user via user terminal 140.

It is noted that the present discussion focuses on a particular application of sentiment extraction that involves extracting sentiment from linguistic statements. However, it should be appreciated that the techniques disclosed herein may also be applicable to other applications of sentiment extraction in which elements of a structure may be used to extract sentiment in accordance with embodiments of the present disclosure. For example, the techniques disclosed herein may also be applicable for determining a sentiment classification for a structure composed of elements, by categorizing the elements, determining a relationship between the elements, and applying a graph-based NLP classification algorithm or model in accordance with embodiments of the present disclosure. As such, the discussion herein with respect to sentiment extraction from linguistic statements should not be construed as limiting in any way.

It is also noted that the functional blocks, and components thereof, of system 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User interface 140 may be implemented as, or as part of, a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user interface 140 may be configured to provide an interface (e.g., a graphical user interface (GUI)) structured to facilitate a user interacting with system 100, e.g., via network 145, to execute and leverage the features provided by server 110. In embodiments, the user may be enabled, e.g., through the functionality of user terminal 140, to provide configuration parameters that may be used by system 100 to provide functionality for performing sentiment extraction using graph-based NLP model(s). In embodiments, user terminal 140 may be configured to communicate with other components of system 100. In embodiments, the functionality of user terminal 140 may include receiving results from server 110 (e.g., results of sentiment extraction operations) and/or displaying the results of the sentiment extraction operations to the user via the GIU of user terminal 140.

In embodiments, server 110, sources 130, and user interface 140 may be communicatively coupled via network 145. Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc. In some embodiments, server 110, sources 130, and user interface 140 may be communicatively coupled directly to each other, without routing through network 145, such as via a direct connection between sources 130 and server 110, and/or a direct connection between user interface 140 and server 110.

Server 110 may be configured to facilitate operations for extracting sentiment from statements using graph-based NLP classification models. In some embodiments, extracting sentiment from statements using graph-based NLP classification models may include receiving an input statement, dividing the input statement into a set of bigrams, each bigram composed of a respective pair of neighboring words in the input statement, identifying, for each bigram of the set of bigrams, a relationship between the respective neighboring words in each bigram using a graph-based NLP classification model, determining a sentiment classification for each bigram of the set of bigrams based on a relationship between the respective neighboring words of each bigram, and determining an overall sentiment classification for the input statement based on a summation of the sentiment classification for each bigram of the set of bigrams. The functionality of server 110 may be provided by the cooperative operation of the various components of server 110, as will be described in more detail below.

In embodiments, a bigram may refer to a pair of words in a statement. For example, in the statement “North American stocks close higher,” bigrams may include word pairs including {North, American}, {American, stocks}, {stocks, close}, and {close, higher}.

Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure.

Furthermore, those of skill in the art would recognize that although FIG. 1 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 1, server 110 includes processor 111, memory 112, database 126, preprocessor 120, bigram generator 121, relationship determination engine 122, and sentiment extractor 123. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 126 for storing various information related to operations of system 100. In some embodiments, database 126 may store configuration parameters related to operations of system 100, such as user information, authentication information, predetermined thresholds, etc. In some embodiments, database 126 may store machine learning models, mathematical models, artificial intelligence models, rules models, algorithms, and/or other models that may be used by components of server 110 to perform sentiment extraction in accordance with embodiments herein. In some embodiments, the graph-based NLP model may include one or more of the machine learning models, mathematical models, artificial intelligence models, rules models, algorithms, and/or other models stored in database 126. Database 126 is illustrated as integrated into memory 112, but in some embodiments, database 126 may be provided as a separate storage module or may be provided as a cloud-based storage module. Additionally, or alternatively, database 126 may be a single database, or may be a distributed database implemented over a plurality of database modules.

Preprocessor 120 may be configured to process the input statement to condition the input the statement for processing by the graph-based NLP model (e.g., model 127). In a conventional NLP classification system, an input statement may be preprocessed, but the preprocessing may include several stages including string splitting, filtering, stemming, lemmatization, tokenization, and vectorization. Preprocessor 120 may be configured to perform string splitting, filtering, stemming, lemmatization, tokenization, and/or vectorization as in conventional systems, but preprocessor 120 may also be configured to enhance the preprocessing. For example, preprocessor 120 may provide an enhanced mechanism for identifying and/or tagging colocations and filtered stop words. In addition, preprocessor 120 may condition the input statement without applying all preprocessing stages mentioned above (e.g., string splitting, filtering, stemming, lemmatization, tokenization, and vectorization). For example, in some embodiments, preprocessor 120 may be configured to forego applying vectorization to the input statement. In this manner, the input statement may be filtered, stemmed, lemmatized, and/or tokenized, but no vectorization may be performed.

In embodiments, string splitting may include splitting the input statement into digestible ‘chunks’ for further preprocessing. For example, the input statement may be represented by a string, and preprocessor 120 may be configured to split the string into the chunks for further preprocessing. In some embodiments, the input statement may be split based on a particular element, such as a character, etc. For example, an input statement may be split based on a white space (e.g., the statement “The Federal Reserve has signaled four rate hikes for 2022” may be split based on white space into the following chunks: “The,” “Federal,” “Reserve,” “has,” “signaled,” “four,” “rate,” “hikes,” “for,” “2022”). In this manner, and in some embodiments, string splitting may split an input statement into its constituent words.

In implementations, some of the chunks may be related to each other. For example, where chunks represent words, some of the words may be related to each other as colocations. A colocation may refer to one or more words which, although having a meaning by themselves, or being meaningful within a particular context, may have a different meaning, or may be meaningful in a different context, when located next to each other. For example, each of the words “Federal” and “Reserve” may have a meaning by itself. However, when collocated (e.g., as in “Federal Reserve”) the colocation of these words may have a meaning that may be different than the meaning of the individual words, or that may be meaningful in a different context.

In some embodiments, preprocessor 120 may be configured to consider punctuation when performing string splitting. For example, a punctuation at the end of a statement may be determined to be meaningful and may be split as a chunk, or may be determined to not be meaningful, in which case the punctuation may not be split as a chunk and may be ignored.

In embodiments, filtering may include text filtering of the input statement to remove text artifacts and words that may be determined to lack a contribution or a sufficient contribution of informational content to the overall message in the input statement. For example, following the example above, the words “the” and “for” may be determined to be common and, based on the determination that these words are common words, these words may be determined to provide little information content to the meaning of the statement. In embodiments, these types of words lacking contribution, or lacking sufficient contribution, to the meaning of the input statement may be referred to as “stop words.” In embodiments, stop words may be filtered out of the input statement. In embodiments, filtering may include removing artifacts (e.g., stray punctuation marks, numbers, and/or other unwanted artifacts) from the input statement left over, such as from the string splitting state and/or other text processing.

In embodiments, stemming may include determining, identifying, and/or accounting for different forms of a particular word. For example, preprocessor 120 may be configured to determine that “carry” and “carries” may have a common root word “carry.” In this case, preprocessor 120 may account for the various form of these words by representing this root as a “carr.” In embodiments, the results of the stemming stage need not obey proper spelling.

In embodiments, lemmatization may include determining a common root of a word in a statement more intelligently than when compared with the stemming state. For example, while stemming may imply a process to ‘chop off’ the ends of words in order to arrive at a common root, lemmatization may employ further processing to actually understand the grammatical context of each word and arrive at a common root more intelligently. The end result of lemmatization of a word may include a lemma or form of the word one might find in a dictionary.

In embodiments, tokenization of the input statement may include tokenizing each of the words in the input statement into a form digestible by the graph-based NLP classification model. In some embodiments, tokenization of an input statement may include obtaining a count of the words in the input statement, such as in a histogram of the input statement, or may include representing he words in the input statement as a binary string.

In embodiments, vectorization may include generating a vector for each word in the input statement. In some embodiments, the input statement may be vectorized using a binary strings approach. In these embodiments, each word in the input statement may be represented by a vector that is formed by representing the presence of a word in the input statement as a single ‘1’ in a binary string relative to an index. In alternative or additional embodiments, the input statement may be vectorized using a count vectorization approach. In these embodiments, each word in the input statement may be represented by a vector that is formed by representing the presence of a word in the input statement as a count of the number of times each word appears in the input statement. In alternative or additional embodiments, the input statement may be vectorized using a term frequency-inverse document frequency (TF-IDF) approach. In these embodiments, each word in the input statement may be represented by a vector that represents the count of token (e.g., how many times the token appears in the input statement) weighted by the number of appearances of the token in the entire document (e.g., the entire document that includes the input statement, such as the entire document from which the input statement is extracted or received). In embodiments, the IF-IDF approach may provide a broad scale representation of each word across multiple input statements.

It is noted that the above vectorization approaches may be thought of as “bag of words” models, as these approaches represent a collection of words (in some cases weighted in some way by their frequency) without regard to the order of the words in the input statement.

It is noted that at every preprocessing stage described above, the informational content of the original input statement may be reduced in some way. For example, stemming may omit plurality or tense, and string splitting may not account for valuable colocations. In conventional systems, these characteristics of the preprocessing operations may result in requirements of great effort, resources, and computational time in order to optimize the overall NLP classification pipeline for a particular application. In embodiments of the present disclosure, preprocessor 120 may be configured to enhance the preprocessing operations.

For example, in embodiments, preprocessor 120 may be configured to provide an enhanced mechanism for identifying and/or tagging colocations in the input statement. In particular embodiments, preprocessor 120 may be configured with a collection of colocations that may help the graph-based NLP classification model (e.g., model 127) to “understand” common colocations, or word-pairs, based on the particular application in which the graph-based NLP classification model may be used. For example, the graph-based NLP classification model of embodiments may be used in a financial application (e.g., a trading platform, a financially analysis platform, etc.). In this case, preprocessor 120 may be configured with a collection of colocations tailored to the financial application that may help the graph-based NLP classification model (e.g., model 127) to “understand” common colocations in the financial field. For example, the colocation “Federal Reserve,” when taken as two distinct words, may have different connotations as the graph-based NLP classification model may use “Federal” and “Reserve” as two distinct nouns. However, in this example, preprocessor 120 may be configured to identify “Federal Reserve” as a colocation used in the particular application (e.g., the financial application) in which the graph-based NLP classification model is being used. Thus, in some embodiments, a determination may be made as to an application (e.g., field, context, etc.) in which the graph-based NLP classification model is to be used and a set of colocations applicable to the application may be used by preprocessor 120 based on the determined application.

In embodiments, preprocessor 120 may be configured to provide an enhanced mechanism for identifying and/or tagging stop words in the input statement. In particular embodiments, preprocessor 120 may be configured with a collection of stop words that may be based on the particular application in which the graph-based NLP classification model may be used. In embodiments, the collection of stop words that may be based on the particular application may facilitate identification and tagging of stop words that may be missed by conventional systems. For example, most conventional systems include the words “up” and “down” as stop words that are filtered out of the input statement (and thus not considered by the classification model). This may be problematic in the application or context of financial services, as the words “up” and “down” carry significant meaning within the financial services context. For example, the sentences “Stocks went up today” and “Stocks went down today” may evaluate to the same input statement after filtering (e.g., “Stocks went today”), which may be very problematic as the meaning of the two sentences is quite different when the words “up” and “down” are considered. However, in this example, preprocessor 120 may be configured to not filter out the words “up” and “down” from the two sentences above when the particular application in which the graph-based NLP classification model is being used is related to financial services. Thus, in some embodiments, a determination may be made as to an application (e.g., field, context, etc.) in which the graph-based NLP classification model is to be used and a set of stop words applicable to the application may be used by preprocessor 120 based on the determined application.

Bigram generator 121 may be configured to generate a set of bigrams based on the input statement. For example, in some embodiments, bigram generator 121 may be configured to divide the input statement into the set of bigrams by generating word-pairs from neighboring words in the input statement. For example, for the input statement “North American stocks close higher,” after preprocessing of the input statement, bigram generator 121 may generate a set of bigrams by generating bigrams from each word-pair that may be composed from neighboring words in the input statement and including the bigrams in the set of bigrams. For example, the set of bigrams for the above input statement may include the bigrams {North, American}, {American, stocks}, {stocks, close}, and {close, higher}, where each bigram may represent a word-pair composed from each neighboring word pair in the input statement. In this manner, bigram generator 121 may be configured to generate a set of bigrams based on the input statement.

Relationship determination engine 122 may be configured to identify, for each bigram of the set of bigrams generated by bigram generator 121, a relationship between the neighboring words composing each of the bigrams in the set of bigrams. In embodiments, relationship determination engine 122 may be configured to identify a relationship between the neighboring words composing each of the bigrams in the set of bigrams using a graph-based NLP classification model, such as graph-based NLP classification model 127. For example, in embodiments, a graph model may be generated for the input statement, where each node of the graph model may be associated with one of the words in the input statement and a relationship between two nodes of the graph model may include information for determining a sentiment classification associated with the relationship between the two nodes.

In embodiments, graph-based NLP classification model 127 may represent an NLP classification model that may be graph-based in nature. Conventional graph models operate by extrapolating a graph model from known nonlinear neural network model. In contrast to conventional graph models, the graph-based NLP classification model of embodiments (e.g., graph-based NLP classification model 127) operates to generate a graph model in which each node of the graph model may represent an equivalence class and the edges between nodes may represent a relationship between the equivalence classes represented by the node.

In embodiments, configuring graph-based NLP classification model 127 to operate may include extrapolating a list of abstract nodes, where each abstract node may represent an equivalence class. In some embodiments, a thesaurus may be used to extrapolate the list of abstract nodes by configuring the abstract nodes such that each node represents an equivalence class of synonyms based on the thesaurus, or other data set containing equivalence classes of words. For example, the thesaurus used in embodiments may include “rise” and “soar” as related in meaning, such as related as synonyms. In this example, rise” and “soar” may be included in the same equivalence class. In this manner, graph-based NLP classification model 127 may be configured to consider each node in a graph model for an input statement not as relevant to specific words, but rather as relevant to an equivalence class. Further in this manner, a graph model may be generated for an input statement by determining to which equivalence class each word in the input statement belongs (e.g., based on the synonym between each word and the equivalence classes based on the thesaurus) and generating a node for each word in the input statement, where each node represents the equivalence class to which the corresponding word belongs.

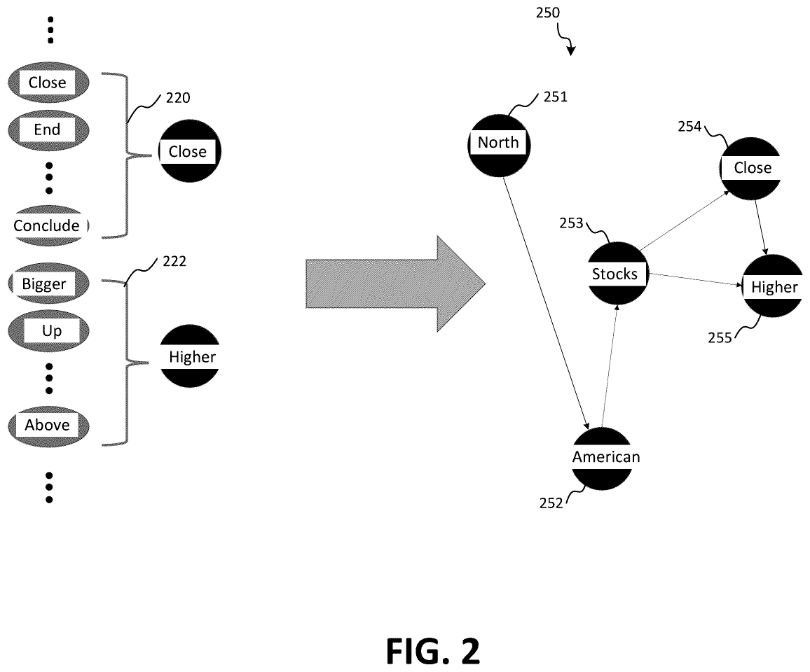

For example, with reference to FIG. 2, for the input statement “North American stocks close higher,” each word in the input statement may be assigned to an equivalence class based on a relationship between each word and the equivalence classes. For example, the word “close” may be assigned to equivalence class 220, as equivalence class 220 may represent a class of words that may be synonyms to the word “close.” Similarly, the word “higher” may be assigned to equivalence class 222, as equivalence class 222 may represent a class of words that may be synonyms to the word “higher.” In some embodiments, the equivalence classes may be determined based on a thesaurus or a list of synonyms, from which words that are synonyms to each other may be assigned to a same equivalence class.

In embodiments, graph model 250 may be generated from the input statement, where each node of graph model 250 is associated with a word in the input statement. In particular, each node of graph model 250 may represent an equivalence class to which the words associated with each node belongs. For example, node 251 may be associated to word “North” and may represent an equivalence class to which “North” belongs, node 252 may be associated to word “American” and may represent an equivalence class to which “American” belongs, node 253 may be associated to word “stocks” and may represent an equivalence class to which “stocks” belongs, node 254 may be associated to word “close” and may represent an equivalence class to which “close” belongs, and node 255 may be associated to word “higher” and may represent an equivalence class to which “higher” belongs.

In embodiments, the edges between each node of graph model 250 may represent a relationship between the equivalence classes represented by the node, and these relationships may be generated by relationship determination engine 122 using graph-based NLP classification model 127. In particular, relationships between nodes of graph model 250 may be formed based on a training set. There is an analogy of the techniques disclosed herein with respect to operations of graph-based NLP classification model 127 to the human brain's interpretation of language that may facilitate understanding of the techniques disclosed herein. For example, the human brain consists of a vast network of wildly competing neurons and groups of neurons. Macroscopic thoughts are purported to be the result of competing sub networks of neurons firing in a symphony of electrical competition. Implicit in this ensemble is the concept of associativity. In the brain, no neural or neuronal subnetwork is alone. Each neural or neuronal subnetwork is inextricably linked to the entire network of neural or neuronal subnetworks of the brain and hierarchies of subnetworks therein by a vast array of neuronal connections. At present, the computational complexity of simulating this array at the human level is untenable. However, it will be appreciated that the techniques disclosed herein, such as through graph-based NLP classification model 127, provide a mechanism for bypassing the vast computations and complexity requirements by leveraging the previously identified word relationships (e.g., via the equivalence class approach to the graph model nodes) to simulate the associativity forged by time and vast organic computational complexity in the brain.

In embodiments, and in general terms, the relationships between nodes of graph model 250 may be generated based on predefined labels in the corpus associated with the input statement. In embodiments, graph-based NLP classification model 127 may be trained to observe the relationship between proximal words in the input statement as grouped by label. In this manner, relationships between words of the input statement, which may correspond to the nodes of the graph model, may not just be taken at the directly proximal (e.g., direct neighbors) but also secondary, tertiary, etc. neighbors. In embodiments, the occurrence of a relationship between two words (e.g., two neighboring words) may be established and may then be subsequently iterated based on frequency. In this manner, a graph database between all nodes in the graph model may be formed with the relationship between two neighboring nodes relative to the distance between the word neighbors (e.g., proximal, secondary, tertiary, etc.), which may be referred to as proximal dimension, being considered in the determination of the relationship itself between words, or a weighting on the frequency increment within the singular relationship between two words of the input statement.

More particularly, graph-based NLP classification model 127 may determine a relationship between two words of the input statement, such as to be included in graph model 250, using a set of frequencies with respect to labels associated with the two words. For example, in general terms, the relationship R between node A and B may be represented using Equation 1 below.

(A)-[R]->(B) (1)

In this case, subcomponents of the relationship frequencies by label may be expressed as in Equation 2.

(A)-[R{x₁:n₁, . . . ,yₘ:nₘ}]->(B) (2)

where x₁:n₁, . . . , xₘ:nₘ

In embodiments, relationship determination engine 122 may be configured to determine a sentiment classification for each bigram of the set of bigrams based on the relationship between the respective neighboring words of each bigram.

In embodiments, sentiment extractor 123 may be configured to determine an overall sentiment classification for the input statement based on a summation of the sentiment classification for each bigram of the set of bigrams.

It is noted that other types of devices and functionality may be provided according to aspects of the present disclosure and discussion of specific devices and functionality herein have been provided for purposes of illustration, rather than by way of limitation. It is noted that the operations of a method may be performed in any order, or that operations of one method may be performed during performance of another method. It is also noted that a method may also include other functionality or operations consistent with the description of the operations of the system 100 of FIG. 1.

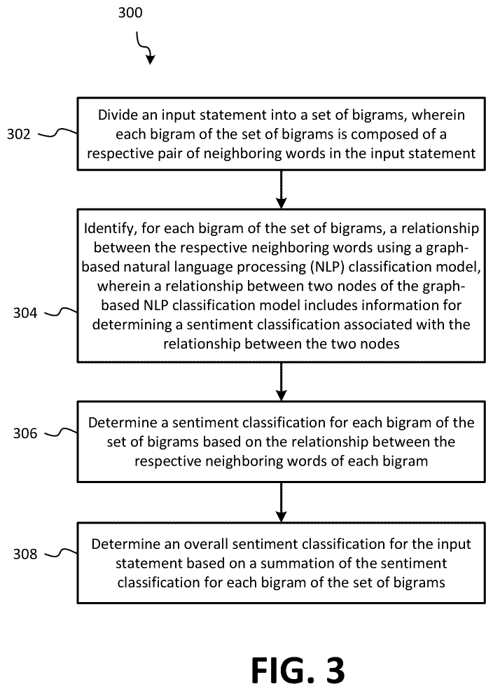

FIG. 3 depicts yet another embodiment of the present disclosure. A method of identifying sentiment of a statement 300 may begin at step 302, where an input statement is divided into a set of bigrams, each bigram of the set of bigrams composed of a respective pair of neighboring words in the input statement. In embodiments, functionality of a bigram generator (e.g., bigram generator 121 as shown in FIG. 1) may be used to divide an input statement into a set of bigrams. In embodiments, the bigram generator may perform operations to divide an input statement into a set of bigrams according to operations and functionality as described above with reference to bigram generator 121 and as illustrated in FIGS. 1-2.

At block 304, a relationship between the respective neighboring words is identified, for each bigram of the set of bigrams, using a graph-based NLP classification model. In embodiments, a relationship between two nodes of the graph-based NLP classification model includes information for determining a sentiment classification associated with the relationship between the two nodes. In embodiments, functionality of a relationship determination engine (e.g., relationship determination engine 122 as shown in FIG. 1) may be used to identify, for each bigram of the set of bigrams, a relationship between the respective neighboring words using a graph-based NLP classification model. In embodiments, the relationship determination engine may perform operations to identify, for each bigram of the set of bigrams, a relationship between the respective neighboring words using a graph-based NLP classification model according to operations and functionality as described above with reference to relationship determination engine 122 and as illustrated in FIGS. 1-2.

At block 306 a sentiment classification for each bigram of the set of bigrams is determined based on the relationship between the respective neighboring words of each bigram. In embodiments, functionality of a relationship determination engine (e.g., relationship determination engine 122 as shown in FIG. 1) may be used to determine a sentiment classification for each bigram of the set of bigrams based on the relationship between the respective neighboring words of each bigram. In embodiments, the relationship determination engine may perform operations to determine a sentiment classification for each bigram of the set of bigrams based on the relationship between the respective neighboring words of each bigram according to operations and functionality as described above with reference to relationship determination engine 122 and as illustrated in FIGS. 1-2.

At block 308 an overall sentiment classification for the input statement is determined based on a summation of the sentiment classification for each bigram of the set of bigrams. In embodiments, functionality of a sentiment extractor (e.g., sentiment extractor 123 as shown in FIG. 1) may be used to determine an overall sentiment classification for the input statement based on a summation of the sentiment classification for each bigram of the set of bigrams. In embodiments, the sentiment extractor may perform operations to determine an overall sentiment classification for the input statement based on a summation of the sentiment classification for each bigram of the set of bigrams according to operations and functionality as described above with reference to sentiment extractor 123 and as illustrated in FIGS. 1-2.

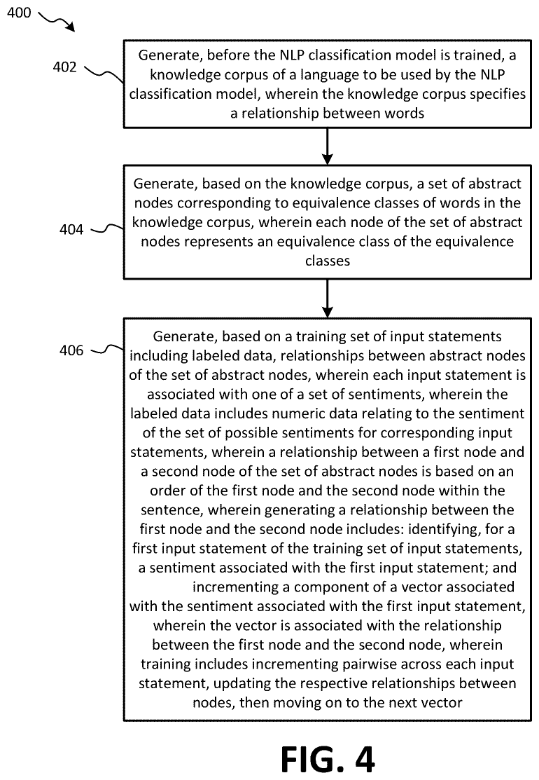

FIG. 4 depicts yet another embodiment of the present disclosure. A method of training a graph-based NLP classification model 400 may begin at step 402, where a knowledge corpus of a language to be used by the NLP classification model is generated before the NLP classification model is trained. In embodiments, the knowledge corpus specifies a relationship between words.

At block 404, a set of abstract nodes corresponding to equivalence classes of words in the knowledge corpus is generated based on the knowledge corpus. In embodiments, each node of the set of abstract nodes represents an equivalence class of the equivalence classes.

At block 406, relationships between abstract nodes of the set of abstract nodes are generated based on a training set of input statements including labeled data. In embodiments, each input statement is associated with one of a set of sentiments, and the labeled data includes numeric data relating to the sentiment of the set of possible sentiments for corresponding input statements. In embodiments, a relationship between a first node and a second node of the set of abstract nodes is based on an order of the first node and the second node within the sentence. In embodiments, generating a relationship between the first node and the second node may include identifying, for a first input statement of the training set of input statements, a sentiment associated with the first input statement, and incrementing a component of a vector associated with the sentiment associated with the first input statement. In embodiments, the vector is associated with the relationship between the first node and the second node, and training may include incrementing pairwise across each input statement, updating the respective relationships between nodes, then moving on to the next vector.

In embodiments, systems, method, and devices may be configured to control one or more physical components, devices, and/or indicators based on a risk validation that is based on analysis using the functionality for extracting sentiment from statements using graph-based NLP classification models disclosed herein, and one or more risk indicators. The risk indicators may be configured to process a set of data associated with a particular action, decision, choice, etc., having an associated risk, and provide an indication that may be used to validate the decision (e.g., to indicate whether the decision is valid or invalid with respect to a risk). In embodiments, a valid decision may have a higher likelihood of avoiding a risk than an invalid decision.

In embodiments, a system (e.g., a server including a processor and memory such as server 110 of FIG. 1) may receive an indication of an action, decision, choice, etc., may be received. For example, the decision may include a decision to buy a financial instrument, to sell the financial instrument, to hold the financial instrument, or a decision related to other non-financial actions. In embodiments, the decision may be related to a risk. For example, a buy decision may be associated with a risk that the financial instrument may not increase in value but may instead drop in value in which case the buy action may result in a loss.

In embodiments, the decision may be based on a first set of data related to the decision. For example, a buy, sell, or hold decision may be made on a first set of data associated with the financial instruments. The first set of data may include a price chart of the financial instrument.

In embodiments, the system may validate the decision based on one or more a sentiment extraction process (e.g., such as based on embodiments of the present disclosure) related to a second set of data related to the decision (e.g., different from the first set of data, and may include news information (e.g., headlines) associated with the decision), and/or based on application of one or more risk indicators (e.g., the Kovach indicators disclosed herein) applied to the first set of data related to the decision.

In embodiments, validating the decision may include determining whether a risk associated with the decision is likely to occur, such that taking the action of the decision may result in a result that is contrary to the decision. For example, validating a buy decision to buy a financial instrument may include determining, based on the sentiment extraction process applied to headlines associated with the financial instrument and/or applying one or more Kovach indicators to the price chart of the financial instrument, whether the buy decision should be followed or not. In embodiments, following the buy decision may include actually buying the financial instrument and not following the decision may include not buying the financial instrument.

In this manner, validating a decision may include determining, based on sentiment extraction and one or more Kovach indicators, whether the conditions of the market or field associated with the decision support the decision.

In embodiments, validating the decision may include determining whether the decision is valid or invalid. In embodiments, the system may generate an activation signal, based on whether the signal is valid or invalid, to activate a physical device, component, or indicator configured to indicate the validation decision (e.g., whether the decision is valid or invalid). In embodiments, the physical device may include a physical light, a physical screen, a graphical indicator, a physical flag, etc. For example, in embodiments, the physical device may include a lamp that may be configured to show the status of the validation decision (with a green color indicating that the decision is valid and a red color indicating that the decision is invalid).

In embodiments, validating the decision may include determining a current market condition. For example, the system may determine, based on the Kovach indicators, a current market condition of the market to which the decision is related to. The current market condition may include one of: oversold, sell, neutral, buy, and overbought. In embodiments, the current market condition may be used to validate whether the decision is valid or invalid.

In some embodiments, activating the physical device to show the indication of whether the decision is determined to be valid or invalid includes presenting the current market condition. For example, activating the physical device to show the indication of whether the decision is determined to be valid or invalid may include showing whether the market is oversold, sell, neutral, buy, and overbought. In embodiments, each of the condition may correspond to a different type of indicator. For example, each of the conditions may correspond to a different color (e.g., light green may correspond to a buy condition, red may correspond to a sell condition, yellow may correspond to a neutral condition, orange may correspond to an oversold condition, and dark green may correspond to an overbought condition).

In embodiments, a method of controlling one or more physical components, devices, and/or indicators based on a risk validation that is based on analysis using the functionality for extracting sentiment from statements using graph-based NLP classification models disclosed herein, and one or more risk indicators is provided. The method may include receiving data related to a market condition. The data may include news information (e.g., headlines) associated with a financial instrument, and/or price information (e.g., price charts) associated with the financial instrument. In embodiments, the data may be analyzed for sentiment extraction (e.g., in accordance with the sentiment extraction techniques disclosed herein) from the news information, and/or one or more risk indicators (e.g., Kovach indicators) may be applied to the price information, to determine a current market state.

In embodiments, the method may include generating a signal indicating the current market state.

In embodiments, the method may include using the signal to activate a physical device or indicator to indicate the current market state.

In embodiments, the physical device may include a physical light, a physical screen, a graphical indicator, a physical flag, etc. In embodiments, the current market state may include one of: oversold, sell, neutral, buy, and overbought.

In embodiments, activating the physical device or indicator to indicate the current market state may include displaying a different indicator for each of different market conditions. For example, in some embodiments, a light may indicate the current market state, where a light green light may correspond to a buy market state, a red light may correspond to a sell market state, a yellow light may correspond to a neutral market state, an orange light may correspond to an oversold market state, and a dark green light may correspond to an overbought market state.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the present disclosure may include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method of identifying sentiment of a statement, the method comprising:
dividing an input statement into a set of bigrams, wherein each bigram of the set of bigrams is composed of a respective pair of neighboring words in the input statement;
identifying, for each bigram of the set of bigrams, a relationship between the respective neighboring words using a graph-based natural language processing (NLP) classification model, wherein a relationship between two nodes of the graph-based NLP classification model includes information for determining a sentiment classification associated with the relationship between the two nodes;
determining a sentiment classification for each bigram of the set of bigrams based on the relationship between the respective neighboring words of each bigram; and
determining an overall sentiment classification for the input statement based on a summation of the sentiment classification for each bigram of the set of bigrams.

2. The method of claim 1, wherein using the graph-based NLP classification model includes associating each word in the respective pair of neighboring words from the input statement of a bigram of the set of bigrams with a node of the graph-based NLP classification model.

3. The method of claim 2, wherein identifying the relationship between the respective neighboring words of the bigram using the graph-based NLP classification model includes identifying a link between a node associated with a first word of the respective neighboring words and a node associated with a second word of the respective neighboring words from the input statement.

4. The method of claim 2, wherein each node of the graph-based NLP classification model represents an equivalence class of synonyms to which each word from the input statement is respectively associated.

5. The method of claim 4, wherein associating each word in the respective pair of neighboring words of the bigram with a node of the graph-based NLP classification model includes:
determining an equivalence class associated with each word in the respective pair of neighboring words of the bigram;
assigning each word in the respective pair of neighboring words of the bigram to a node representing the respective associated equivalence class; and
creating the node representing the respective associated equivalence class when the node representing the respective associated equivalence class is absent from the graph-based classification model.

6. The method of claim 1, wherein the spacing between neighboring words of a respective pair of neighboring words in a bigram is greater than one indicating that the neighboring words of the respective pair of neighboring words are associated to each other as higher than primary neighbors, and wherein a weighting of a relationship between adjacent neighboring words decreases as a distance between the adjacent neighboring words increases.

7. The method of claim 1, wherein information for determining a sentiment classification associated with a relationship between each two nodes of the graph-based NLP classification model includes a sentiment vector including a plurality of components, each component of the plurality of components representing a different sentiment of a set of possible sentiments.

8. The method of claim 7, wherein determining the overall sentiment classification for the input statement includes:
summing each component of the sentiment vector for each two nodes representing each of the set of possible sentiments, wherein a sum of a first component of the sentiment vector for each two nodes representing a first sentiment of the set of possible sentiments, each sentiment classification for each bigram of the set of bigrams based on the relationship between the respective neighboring words of each bigram; and
identifying a maximal value in the sentiment vector; and
determining the overall sentiment classification based on a respective dimension corresponding to the maximal value in the sentiment vector.

9. A method of training a graph-based natural language processing (NLP) classification model, the method comprising:
generating, before the NLP classification model is trained, a knowledge corpus of a language to be used by the NLP classification model, wherein the knowledge corpus specifies a relationship between words;
generating, based on the knowledge corpus, a set of abstract nodes corresponding to equivalence classes of words in the knowledge corpus, wherein each node of the set of abstract nodes represents an equivalence class of the equivalence classes; and
generating, based on a training set of input statements including labeled data, relationships between abstract nodes of the set of abstract nodes, wherein each input statement is associated with one of a set of sentiments, wherein the labeled data includes numeric data relating to the sentiment of the set of possible sentiments for corresponding input statements, wherein a relationship between a first node and a second node of the set of abstract nodes is based on an order of the first node and the second node within the sentence, wherein generating a relationship between the first node and the second node includes:
identifying, for a first input statement of the training set of input statements, a sentiment associated with the first input statement; and
incrementing a component of a vector associated with the sentiment associated with the first input statement, wherein the vector is associated with the relationship between the first node and the second node, wherein training includes incrementing pairwise across each input statement, updating the respective relationships between nodes, then moving on to the next vector.

10. The method of claim 8, wherein the frequency of observations includes a frequency of observations for a set of classifications of sentiment.

11. The method of claim 9, wherein the set of classifications of sentiment includes:
risk on;
risk off; and
neutral.

12. The method of claim 9, wherein the frequency of observations for each of the set of classifications of sentiment represents a sentiment weight, and wherein the sentiment weight is calculated based on
R[xᵢ]=R[xᵢ]+α(d), where (Nⱼ)-[R[xᵢ]]->(N_{j+d}), and α: d→ [symbol] ,d∈{1,2,3 . . . ,n}
where xᵢ represents a sentiment for the relationship R[xᵢ],
d corresponds to the distance in the respective word pairs from the set of words in the input statement. Adjacent words would be represented by setting d=1. The if the second word is two words down from the first word, then d=2 and so forth.
α(d) is a real valued function providing the numeric value for which we increment R[xᵢ], decreasing monotonically as d increases
Nⱼ represents the node in the graph corresponding to the word from the set of words in the input statement at position j in the set of words.
N_{j+d} represents the node in the graph corresponding to the word from the set of words in the input statement at position j+d in the set of words. This node corresponds to the dth word away from the word in the input sentence at position j, and
R[xᵢ] represents the component of the vector in the relationship corresponding to the sentiment, xi of the set of possible sentiments.

13. The method of claim 9, further comprising iterating through each of the training set of input statements, wherein at each iteration, the method includes
incrementing, a component of a vector associated with a sentiment of the set of sentiments information associated with a sentiment; and
augmenting the relationships between nodes of the set of abstract nodes to include one or more of: a numeric measurement and a frequency of observations weighted by a proximity of a respective word pair in the set of words from the input statement.
